(19) United States
(12) Patent Application Publication
(10) Pub. No.: US 2023/0250009 A1
(43) Pub. Date: Aug. 10, 2023

(54) HOUSEHOLD GLASSWARE PRODUCT OBTAINED FROM CULLET AND THE PRODUCTION METHOD THEREOF

(71) Applicant: TURKIYE SISE VE CAM FABRIKALARI ANONIM SIRKETI, Istanbul (TR)

(72) Inventors: ARCA IYIEL ORHAN, Kocaeli (TR); Fevziye Hande SESIGUR, Kocaeli (TR); Ergur SEVEN, Kirklareli (TR); Ilker AYGEN, Kirklareli (TR); Burcu APAK, Istanbul (TR)

(73) Assignee: TURKIYE SISE VE CAM FABRIKALARI ANONIM SIRKETI, Istanbul (TR)

(21) Appl. No.: 18/015,092

(22) PCT Filed: Mar. 24, 2021
(86) PCT No.: PCT/TR2021/050260

§ 371 Date: Jan. 9, 2023

(30) Foreign Application Priority Data
Jul. 8, 2020 (TR) 2020/10857

(51) Int. Cl. C03C 3/087; C03C 1/00; C03C 4/02

(52) U.S. Cl. CPC C03C 3/087; C03C 1/002; C03C 4/02

(57) ABSTRACT

A household glassware product manufactured from soda-lime-silica glass cullet includes at most 5% by weight of ZnO and at least 95% by weight of the soda-lime-silica glass cullet selected from the group consisting of recycling glass cullet, internal glass cullet, and a mixture of the recycling glass cullet and the internal glass cullet.

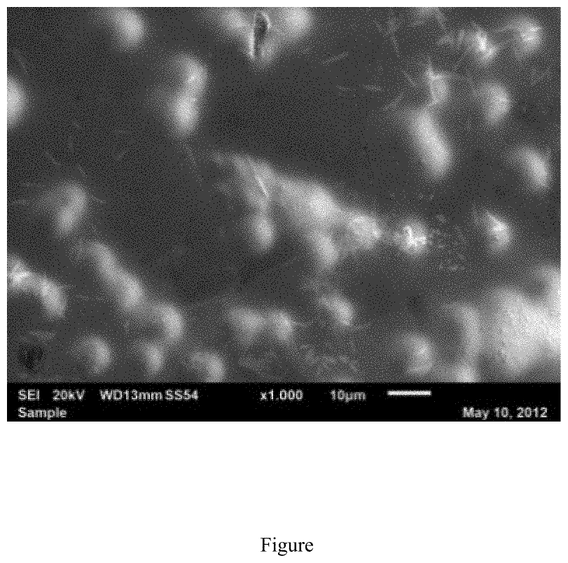

### CROSS REFERENCE TO THE RELATED APPLICATIONS

This application is the national phase entry of International Application No. PCT/TR2021/050260, filed on Mar. 24, 2021, which is based upon and claims priority to Turkish Patent Application No. 2020/10857, filed on Jul. 8, 2020, the entire contents of which are incorporated herein by reference.

### TECHNICAL FIELD

The invention relates to a household glassware product with high chemical corrosion durability and a production method thereof.

### BACKGROUND

In household glassware products, glass is produced from a mixture by using glass raw materials and its internal glass cullet at a low rate (15-40%).

In glass production, the desired impurities and color parameters in glass are important. The desired color, mechanical properties, and durability in the dishwasher of the glass are controlled by adjusting the mixture content and the use of internal glass cullets. The content of raw materials, especially the amount of Fe₂O₃ found as an impurity, is effective on the color parameters of the glass. The high amount of Fe₂O₃ from raw materials increases the need for a decrease in the brightness value of the glass and decolorization mechanisms. In the process of melting the standard soda-lime glass mixture, the energy required for the reactions is higher than the melting of the glass cullets. In addition to this, only internal glass cullet is used in the production of household glassware products to keep the risk of contamination at a low level, to prevent or control the presence of undesirable elements in the glass composition. In glass production, the energy required between the melting from the mixture and the melting of the glass cullet is also different. As it is known in the art, a 10% increase in the use of glass cullet saves approximately 2% of the energy required for melting. It is aimed to reduce the energy requirement in glass production and thus to reduce the production emissions.

The use of glass cullet in household glassware products is provided only with its internal cycles, therefore, the amount of glass cullet produced according to the production type (blowing, capped, press.) cannot exceed 40%. At the same time, the colorlessness rates of glasses obtained by using recycled glass with current techniques are low.

In patent publication no: WO9931022 A1, the production of recyclable colored glass is mentioned. In particular, it relates to amber glass, which is obtained by adding iron, carbon, sulfur, and sulfur compounds to the mixture to give the desired reddish color with mixed colored glass cullet containing green, amber, and colorless glasses. The invention is used to produce recycled green or flint glass from undecomposed mixed colored glass cullet. The invention is particularly useful in producing amber containers or bottles for beverages that require protection from the damaging effects of light, such as beer.

### SUMMARY

The present invention relates to household glassware product glasses, which are obtained with glass cullet and have high durability in dish washers to bring new advantages to the related technical field mentioned above.

The main object of the invention is to provide a glass obtained by using ≥95% glass cullet.

Another object of the invention is to provide a glass obtained by using ≥95% glass cullet.

Another object of the invention is to provide a nearly colorless glass and household glassware product.

Another object of the invention is to provide household glassware product glass with high durability in the dishwasher.

Another object of the invention is to present glass production with increased environmentally friendly properties.

Another object of the invention is to provide a glass and household glassware product in which atmospheric corrosion durability is increased.

The present invention relates to a household glassware product manufactured from soda-lime-silica glass cullet, to realize all the objects mentioned above and that will emerge from the detailed description below. Accordingly, it contains at least 95% by weight of glass cullet selected from a group consisting of recycling, internal glass cullet, or a mixture thereof and at most 5% ZnO. Thus, the durability of the dishwasher increases.

In a preferred embodiment of the invention, the component ratios by weight of said glass cullet composition are as follows.

| | % by |
|---|---|
| Component | weight |
| SiO₂ | 69-73 |
| Al₂O₃ | 1-2 |
| Fe₂O₃ | 0.01-0.1 |
| CaO | 8-11 |
| MgO | 1-4 |
| Na₂O | 12-15 |
| K₂O | 0-1 |
| SO₃ | 0-0.3 |

Another preferred embodiment of the invention is that it contains as a colorant, decolorizing and/or oxidizing agent at least one of the oxides CeO₂, CoO, SeO, and ErₓO_{y} in an amount of not more than <0.5% in total.

Another preferred embodiment of the present invention is that a glass with a thickness of 10 mm, has among the L-a-b color values a value L between 83-89; value a between −4 and 0, value b between −0.5 and 1.5.

Another preferred embodiment of the invention is that the direct thermal expansion value is between 85×10⁻⁷/° C.-89×10⁻⁷/° C.

Another preferred embodiment of the invention is that the refractive index is between values of 1.51-1.52.

Another preferred embodiment of the invention is that it does not corrode in the measurements carried out according to EN 12875 standards.

The present invention is a method of producing household glassware products manufactured from soda-lime-silica glass cullet, to realize all the purposes mentioned above, and that will emerge from the detailed description below. Accordingly, it is produced with a mixture of at least 95% glass cullet and at most 5% ZnO.

### BRIEF DESCRIPTION OF THE DRAWING

FIGURE shows the surface SEM image of the samples belonging to the present SLS composition at the end of 200 washing cycles.

### DETAILED DESCRIPTION OF THE EMBODIMENTS

In this detailed description, the household glassware product and the production method of the invention are explained with examples that will not have any limiting effect, for a better understanding of the subject matter.

In this document, unless otherwise stated, the expression “%” means “% by weight” of the content and the amount of the specified substance.

In this study, a soda-lime-silica glass cullet, whose component ratios are given in table 1 is used. At least 95% soda-lime glass cullet and at most 5% ZnO are fed into the furnace. The ZnO ratio used in an embodiment of the invention is between 1-2%. As the source of glass cullet,

Recycling
1. Glass cullet (internal glass cullet) resulting from the process
2. Combination of these are used.

To achieve the desired melting and refining, glass cullet and/or other raw materials are melted by optimizing the process conditions and heating to high temperatures. The composition of the glass cullet that constitutes 95% of the glass is given in table 1.

TABLE 1
Glass cullet composition

| | % by |
|---|---|
| Component | weight |
| SiO₂ | 69-73 |
| Al₂O₃ | 1-2 |
| Fe₂O₃ | 0.01-0.1 |
| CaO | 8-11 |
| MgO | 1-4 |
| Na₂O | 12-15 |
| K₂O | 0-1 |
| SO₃ | 0-0.3 |

In a preferred embodiment of the invention, the glass cullet composition comprises in the range of 69-71% by weight SiO₂; Al₂O₃ in the range of 1-2%, Fe₂O₃ in the range of 0.01-0.10%; CaO in the range of 8-9%; MgO in the range of 1-3%; Na₂O in the range of 12-14% and K₂O in the range of 0-1%.

The household glassware product obtained with at least 95% glass cullet can be produced in color or flint. The glass cullet composition given above can as a colorant, decolorizing, and/or oxidizing agent contain at least one of the oxides CeO₂, CoO, SeO, and ErₓO_{y} in an amount of not more than <0.5% in total.

The glass production with the glass cullet of the invention is suitable for glass packaging, household glassware product, and flat glass applications.

If it is flint, a glass with a thickness of 10 mm, obtained by glass cullet with the given content has among the L-a-b color parameters, value L* between 83-89; value a* between −4 and 0, value b* between −0.5 and 1.5. In the preferred embodiment a glass with a thickness of 10 mm, obtained by glass cullet has among the L-a-b color parameters, value L* between 84-88; value a* between −3 and −1; and value b* between 0 and 1. In an alternative embodiment, a glass with a thickness of 10 mm, obtained by glass cullet has among the L-a-b color parameters, value L between 85-87; value a between −2 and −1; and value b between 0.5 and 1.5.

Although the mixture of recycling and internal glass cullet is mostly used, in case the color parameters of the final glass product are desired to be the same or close to the colorless glass, the ratio of internal glass cullet use increases. Thus, the impurities coming from outside can be controlled more effectively.

The production of colored household glassware products can be carried out with the use of colorants in the desired color tones.

The glass obtained during production from soda-lime glass is made ready for shaping in forehearth. The direct thermal expansion value of household glassware products obtained after shaping is between values of 85×10⁻⁷/° C.-89×10⁻⁷/° C. Refractive index measurements are between values of 1.51-1.52.

In the invention, to increase the dishwashing durability in products produced by using at least 95% soda-lime-silica glass cullets, ZnO is added at a ratio of 0-5%. This results in glassware products less susceptible to atmospheric corrosion, which can withstand the washing cycle in the dishwasher.

The temperature profile in the dishwasher depends on some parameters such as the duration and number of washing cycles, the pH and the change in pH during washing, the hardness of the water, the composition, and the concentration of the used detergent. Also, the composition of the glass, the secondary treatments applied to the surface, and the storage conditions (atmospheric conditions: humidity, temperature, etc.) are also effective on the corrosion of the glass.

The changes in surface morphology and/or composition may occur with various reactions occurring on the glass surface in an environment containing moisture and water vapor. The reactions that may occur here take place in the form of ion displacement and/or the weakening and breaking of the Si—O bonds.

The changes occurring on the glass surface are accelerated by washing in the dishwasher or an environment containing moisture/water vapor, and although it may not be visible at the beginning, it may become apparent over time.

The effect of metal oxides forming the glass composition on chemical durability occurs through 3 different mechanisms:
1. The lower the hydration temperature of metal oxides in the glass, the higher the chemical durability of the glass. The hydration temperature decreases according to the following metal oxide arrangement; K₂O, Na₂O, BaO, SrO, CaO, MgO, B₂O₃, ZnO. Thus, ZnO provides the highest chemical durability, especially against water vapor.
2. The type of bond (ionic or covalent) varies by the difference in electronegativities of the atoms forming the bond or their atomic diameters. When electrons in a bond are shared unequally by atoms, polarization occurs. The high charge density in the cation and large anions affect polarization. The elements that are inclined to high polarization have a low melting point. Thus, they reduce the viscosity and surface tension of the glass melt and tend to volatilize the glass melt. At the same time, they reduce the chemical durability of the glass surface.
   In this case, the higher the atomic refraction (the ability of the bonding atoms to polarize), the higher the chemical durability of the undisturbed glass surface, as well as the volatility of the oxides. The oxides formed by cations with high atomic refraction depart more easily from the glass surface during the glass production process. This results in the household glassware product surface being rich in silica. In this embodiment, atomic refraction of 16 or more is considered high. For example, this is the case for Ba, Pb, Ti, and Zr. The atomic refraction of the elements Mg, Al, Si, K, Zn Ca increases from 6 to 10, respectively.
3. The chemical durability depends on the degree of ionization in the glass (the ratio of the amount of ionic bond to the number of covalent bonds between M-O bonds in the structure). The atoms in the glass structure create either ionic or covalent bonds and the high degree of ionization corresponds to the lower chemical durability. Among the oxide bonds in glass, the ionization degrees of K—O, Na—O, Ba—O, and Ca—O are high (1-2.5), that of Al—O and Zn—O is 1 and that of Si—O and B—O bonds is low (0.7-0.5).

In the light of the information given here, for the glass composition to have higher durability in the dishwasher than basic soda-lime glass, ZnO, water, and water vapor are used, and thus it provides high chemical durability to glass against applications requiring high temperatures, such as sterilization and washing in the dishwasher.

The durability in the dishwasher of newly produced samples belonging to composition trials was examined for 500 cycles within the framework of the standard “EN 12875/1”. Mechanical dishwashing resistance of utensils—Part 1: Reference test method for domestic articles

The washing cycle conditions are given below:

Cold prewash (5 min., 20° C., 6±0.5 L water)

Main wash with detergent (30 min., 60° C., 6±0.5 L water)

Rinsing (3 min., 20° C., 6±0.5 L water)

Rinse aid+Final Rinsing (20 min., 65° C., 6±0.5 L water)

Drying (10 min., the hatch closed, 30 min. hatch opened)

Water hardness: 0.3-0.6 mmol/L

Detergent: Powder, Type C* (24±3 g)

Rinse aid: 2.5-3.0 g

The household glassware product of the invention containing at least 95% glass cullet and at most 5% ZnO content was evaluated at the end of every 10 wash cycles in terms of clouding and tempering of the entire surface according to the standard “EN 12875/2”. Mechanical dishwashing resistance of utensils—Part 2: Inspection of non-metallic articles. Standard criteria numbered EN 12875/2 are given below.

Ranking Degree Observation Result
0 No change
1 The first noticeable change
2 Visible change

The examination results are given in Table 2. There was no difference between the dishwasher washing durability of the newly produced samples of the present soda-lime-silica (hereinafter may be referred to as SLS in the text) composition and the ZnO-containing composition.

TABLE 2
The examination results of newly produced samples of
composition trials according to EN 12875/1 standard

| | Shaping type, | 500 |
|---|---|---|
| Composition | mold number | cycles |
| 1% ZnO | Press 52052 | 0 |
| 1% ZnO | Press blow 42405 | 0 |
| 0.5% ZnO | Press 52052 | 0 |
| 0.5% ZnO | Press blow 42405 | 0 |
| SLS | Press 52052 | 0 |
| SLS | Press blow 42405 | 0 |

EN 12875/4 Washing Durability of Household Goods in Dishwasher Fast Method

The durability in dishwasher of newly produced samples belonging to composition trials was examined within the framework of the standard “EN 12875/4. Mechanical dishwashing resistance of utensils—Part 4: Rapid test for domestic ceramic articles”. The samples were immersed in a 0.5% (w/w) detergent solution at a temperature of 75° C. and kept for a total of 64 hours (corresponding to 500 cycles according to EN 12875/16). The samples were evaluated at the end of every 16 hours in terms of clouding and tempering of the entire surface according to the standard “EN 12875/2′. Mechanical dishwashing resistance of utensils—Part 2: Inspection of non-metallic articles”. The examination results are given in Table 3 below. There was no apparent difference between the compositions that could be seen with the naked eye.

TABLE 3
The examination results of newly produced samples of
composition trials according to EN 12875/4 standard

| | Shaping type, | 64 |
|---|---|---|
| Composition | mold number | hours |
| 1% ZnO | Press 52052 | 0 |
| 1% ZnO | Press blow 42405 | 0 |
| 0.5% ZnO | Press 52052 | 0 |
| 0.5% ZnO | Press blow 42405 | 0 |
| SLS | Press 52052 | 0 |
| SLS | Press blow 42405 | 0 |

Atmospheric Corrosion (Aging) Investigations

The samples developed to increase the durability of the automatically produced SLS glass composition against atmospheric corrosion, thus the durability of the dishwasher was obtained by adding ZnO to the composition in Table 1. The atmospheric corrosion durability of the trial production samples was compared with the atmospheric corrosion durability of the present SLS composition. For this purpose, all samples were first subjected to atmospheric corrosion (aged) by being kept in the conditioning cabinet for a certain period and then taken for washing tests.

Atmospheric Corrosion Test of Composition Trial Samples

Newly produced samples of the composition trial were aged in the conditioning cabinet. For this purpose, the samples were exposed to the following ambient conditions, which changed every 12 hours,
12 hours 95% RH, 50° C.
12 hours room conditions.

for 10 days without interruption. The surface of the aged samples was examined before washing. No corrosion detected by the naked eye was detected on the surface of the samples.

Washing Test of Aged Composition Trial Samples

The durability in the dishwasher of the composition trial samples aged in the conditioning cabinet was examined for 500 cycles within the framework of the standard “EN 12875/1 Mechanical dishwashing resistance of utensils—Part 1: Reference test method for domestic articles”. The samples were evaluated at the end of each 10 washing cycles in terms of clouding and tempering of the entire surface according to the standard “EN 12875/2 Mechanical dishwashing resistance of utensils—Part 2: Inspection of non-metallic articles”. The examination results are given in Table 4.

No corrosion was observed after 500 cycles on the surface of aged samples belonging to the 1% and 0.5% ZnO composition trials. The surface of the aged samples belonging to the SLS composition samples was clouded after 200 cycles. The surface of the clouded samples was examined with SEM-EDS and their images are given in the FIGURE. A depletion in Si was observed on the surface of the samples.

TABLE 4
Examination results of aged samples
according to the standard EN 12875/1

| | Shaping type, | 200 | 500 |
|---|---|---|---|
| Composition | mold number | cycles | cycles |
| 1% ZnO | Press 52052 | 0 | 0 |
| 1% ZnO | Press blow 42405 | 0 | 0 |
| 0.5% ZnO | Press 52052 | 0 | 0 |
| 0.5% ZnO | Press blow 42405 | 0 | 0 |
| SLS | Press 52052 | Clouding | Clouding |
| SLS | Press blow 42405 | Clouding | Clouding |

Results of Studies Conducted on Glass Composition

The durabilities of the newly produced and aged samples of the compositions developed to increase the durability of the glass composition against atmospheric corrosion and thus the durability of the dishwasher (in terms of clouding and tempering of the entire surface) were examined for 500 cycles within the framework of the standard “EN 12875/1 Mechanical dishwashing resistance of utensils—Part 1: Reference test method for domestic articles, Part 2: Inspection of non-metallic articles”. No difference was observed between the newly produced composition trial samples. No corrosion was observed on the surface of the samples after 500 cycles.
1. No corrosion was observed after 500 cycles on the surface of aged samples belonging to the 1% and 0.5% ZnO composition trials. The surface of the aged samples belonging to the SLS composition samples was clouded after 200 cycles.

These results showed that ZnO increased the atmospheric durability of the soda-lime-silicate glass composition, thus the durability in the dishwasher of the product.

Glass Composition:

The study aims to increase the chemical durability of the SLS glass composition, thus its durability to atmospheric corrosion and washing in the dishwasher (in terms of clouding and tempering of the entire surface). In this context, 3 different compositions have been produced;
1% ZnO (1% ZnO was added by reducing from SiO₂),
0.5% ZnO (0.5% ZnO was added by reducing from SiO₂),
Current SLS composition,

The durability in the dishwasher of
newly produced and
aged

samples of these compositions was examined for 500 cycles in terms of clouding and tempering of the entire surface in accordance with the standard “EN 12875/1 Mechanical dishwashing resistance of utensils—Part 1: Reference test method for domestic articles”. The obtained results are as follows:
1. No difference was observed between the newly produced composition trial samples.
2. No corrosion was observed after 500 cycles on the surface of aged samples belonging to the 1% and 0.5% ZnO composition trials. The surface of the aged samples belonging to the current SLS composition samples was clouded after 200 cycles.

These results showed that ZnO increased the atmospheric durability of the soda-lime-silicate glass composition, thus the durability in the dishwasher of the product.

The scope of protection of the invention is specified in the attached claims and it cannot be limited to what is explained in this detailed description for the sake of the example. It is clear that a person skilled in the art can provide similar embodiments in the light of the above, without departing from the main theme of the invention.

What is claimed is:

1. A glass manufactured from soda-lime-silica glass cullet, wherein the glass comprises at most 5% by weight of ZnO and at least 95% by weight of the soda-lime-silica glass cullet selected from the group consisting of recycling glass cullet, internal glass cullet, and a mixture of the recycling glass cullet and the internal glass cullet.

2. The glass according to claim 1, wherein the soda-lime-silica glass cullet comprises the following components in percent by weight: 69-73% of SiO₂, 1-2% of Al₂O₃, 0.01-0.1% of Fe₂O₃, 8-11% of CaO, 1-4% of MgO, 12-15% of Na₂O, 0-1% of K₂O, and 0-0.3% of SO₃.

3. The glass according to claim 1, wherein the glass comprises less than 0.5% by weight of one of oxides CeO₂, CoO, SeO, and ErₓO_{y} as a colorant, a decolorizing, and/or an oxidizing agent.

4. The glass according to claim 1, wherein a glass with a thickness of 10 mm has among L-a-b color parameters a value L* between 83-89; a value a* between −4 and 0, and a value b* between −0.5 and 1.5.

5. The glass according to claim 1, wherein a direct thermal expansion value is between 85×10⁻⁷/° C.-89×10⁻⁷/° C.

6. The glass according to claim 1, wherein a refractive index is between values of 1.51-1.52.

7. The glass according to claim 1, wherein the glass does not corrode in measurements carried out according to EN 12875 standards.

8. A method of producing a glass from soda-lime-silica glass cullet, wherein the glass is produced with a mixture of at least 95% of the soda-lime-silica glass cullet and at most 5% of ZnO.

9. The glass according to claim 1, wherein the glass is used in a glass packaging application, a household glassware product application, and a flat glass application.
